(19) United States
(12) Patent Application Publication
(10) Pub. No.: US 2010/0262638 A1
(43) Pub. Date: Oct. 14, 2010

(54) Computing Device Having a Merged Directory Hierarchy From Multiple Filesystems

(75) Inventor: Richard Fitzgerald, London (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/666,934

(22) PCT Filed: Jun. 19, 2008
(86) PCT No.: PCT/GB08/02089

§ 371 Date: May 17, 2010

(30) Foreign Application Priority Data
Jun. 28, 2007 (GB) 0712640.2

(51) Int. Cl. G06F 17/30

(52) U.S. Cl. 707/822; 707/E17.01; 707/829

(57) ABSTRACT

A computing device comprises a plurality of data images for controlling operation of the device, wherein each image contains an independent filesystem containing a directory hierarchy and file list applicable to the contents of that image, and in which the computing device additionally contains a single directory hierarchy and file list applicable to the entire body of embedded software.

The present invention relates to a computing device, and in particular to a computing device having a merged directory hierarchy compiled from multiple file systems so as to provide an improved control of process within and operation of the computing device.

Computing devices are built using multiple ROM images, comprising a CoreOS and one or more ROFS (Read Only File Systems) partitions. Such a configuration is adopted for various reasons, such as enabling easy customisation of the computing device depending upon the language of the geographical region of operation. There are benefits in these images being accessible as a single logical drive, but each has its own directory hierarchy. This invention provides an efficient means of combining the separate directories into a single directory so as to provide improved performance of the computing device.

The term computing device as used herein is to be expansively construed to cover any form of electrical computing device and includes, data recording devices, computers of any type or form, including hand held and personal computers such as Personal Digital Assistants (PDAs), and communication devices of any form factor, including mobile phones, smart phones, communicators which combine communications, image recording and/or playback, and computing functionality within a single device, and other forms of wireless and wired information devices, including digital cameras, MP3 and other music players, and digital radios.

It is now very common for computing devices, especially portable ones, to embed their control commands in the form of controlling software instead of the previously used hard wiring of logic gates to provide the desired command set of functionality. Some application software in addition to the controlling software is embedded in a persistent memory store, which retains its content when the device is powered off. Storage media for such embedded software stores are known generically as ROMs, because Read-Only Memory (ROM) was historically the first type of embedded storage to be used. Embedded software of this type is often referred to as firmware.

The original ROMs used for embedded software were masked; that is, specifically manufactured with the relevant instructions hardwired into an array of transistors fabricated on a silicon substrate. This method of providing embedded software had the advantage of being relatively low-cost, but the disadvantage of being extremely inflexible. Long lead times were required for the software as manufacture was slow, and updating the embedded software or fixing programming errors in devices that had been sold was not possible without remanufacturing the ROMs and ordering a complete product recall.

For complex mass-market computing devices in the consumer electronics segment, these disadvantages are highly significant. For example, the requirement to finalise the contents of the embedded software at a relatively early stage in the manufacturing process was not consonant with the tendency of software development processes to continue finding bugs and errors in code very late on during testing of final pre-production models.

Programmable and reprogrammable ROMs did exist, but their relatively high cost made them unsuitable for low-cost mass-market consumer electronic devices; furthermore, mass production was complex, and for many years those memory devices that were erasable and reprogrammable often required special equipment, such as exposure to intense UV light, to do so. It was not until the late 1990s that the cost of Electronically Erasable Programmable Read Only Memory (EEPROM), which can be easily rewritten by software means, reduced to a price level which made it affordable for mass-market consumer devices.

The ROMs in modern devices typically rely on type of EEPROM know as Flash memory, invented by Fujio Masuoka at Toshiba during the 1980s, to provide a persistent store for embedded software. This type of memory is far better suited for modern computing devices, especially mobile ones. It not only retains its contents when a device is switched off, but it is also relatively inexpensive, has low-power consumption, high packing density (so a lot of it can be packaged into a small space), enables fast retrieval of data, and can be easily rewritten by software means. In essence, such memory when storing the storage commands can be regarded as a modern alternative form of the control commands embedded into devices by hard wiring of configurations of hard wired components when computers were in their infancy in the mid twentieth century.

Technically, of course, the fact that Flash memory is writable means that it is not actually Read Only Memory at all. However, the term ROM still remains in common usage as a term for any software embedded in silicon chips whether it is read-only or not. It should be noted that in practice, all embedded software in devices is protected in some way from accidental erasure or overwriting.

There are two main types of Flash memory.
1. NOR Flash is the more expensive type, and is a direct replacement for the older types of masked ROM. Like them, it allows embedded code to be run directly from memory. Memory that allows embedded code to be run directly is termed XIP (eXecute In Place) memory.
2. NAND Flash, in contrast, is much cheaper than NOR Flash. It is also faster, it is physically more compact, and it supports up to 10 times more write operations. Because of these advantages, NAND Flash is currently the memory of choice for embedding software in the vast majority of computing devices.

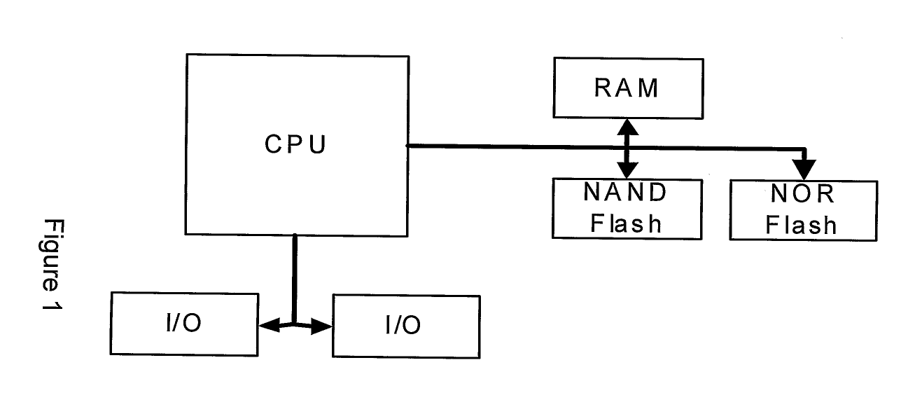

However, NAND Flash has one great disadvantage in that, unlike NOR Flash, it is not XIP (execute in place) memory and does not therefore permit embedded code to be executed directly from it. All code embedded in NAND Flash firstly has to be copied to some writeable type of XIP memory storage, such as Random Access Memory (RAM), before it can be executed. The code for copying the contents of NAND Flash, and then transferring control of the device to some portion of the copied code, is typically provided in a small amount of XIP memory (such as NOR Flash). This architecture for a computing device is shown diagrammatically in FIG. 1.

The need to copy the contents of NAND Flash to RAM has two main disadvantages. The first is that the time taken to make the copy in XIP memory when the computing device is switched on detracts significantly from the user experience. Most people place a high value on being able to use a computing device as quickly as possible after it is powered up, and become very dissatisfied when the device appears not to do so: the user expectation is not met. The second disadvantage is that it can require, in the worst case if alternative measures are not adopted, an amount of RAM to be provided on the device that is equivalent to the amount of NAND Flash memory. Since RAM is expensive in terms of both price and power consumption, it is particularly advantageous to minimise the amount of RAM that is needed to execute the code held in the Flash memory.

These disadvantages are especially important for portable consumer electronic devices such as mobile telephones, where competition between manufacturers has resulted in downward pressure on manufacturing costs, and where users value extended battery life and as short a time as possible from power-on to fully available functionality.

It is known to those skilled in the art that designers and manufacturers of computing devices can minimise the disadvantage of NAND flash by keeping the amount of code that needs to be copied at power-on time to a minimum. One way that this can be done is by dividing the embedded software into two types.
1. The Core Operating System (Core OS) consists of the set of software that is judged to be essential for the startup and continued operation of the device, and this set of software is typically provided in NAND Flash as a single file, from where it is copied to XIP RAM in one operation as a single binary image, and this image contains a filesystem comprising multiple logically separate files. It should be noted that this obviates the need for a file handling system to be stored in the embedded XIP memory and ensures that the necessary copying takes place as quickly as possible when the device is switched on. In general, once copied or shadowed into XIP memory, a core OS image cannot be practically unloaded, even in part; it is known to those skilled in the art that because such core OS images are typically built using a technique known as static linkage, the memory locations they occupy on the device must be regarded as reserved and are not available for reuse by other software. The executable code in the Core OS is therefore in practice kept permanently in RAM during all subsequent operations until the device is powered off, at which time the RAM loses its stored contents because it cannot be refreshed.
2. The remainder of the embedded software is left in NAND Flash and is then loaded to (and subsequently unloaded from) RAM on demand, per module.

There are clear advantages in this architecture in keeping the Core OS as small as possible; this both speeds up the boot process (as there is less data that needs to be copied) and also reduces the amount of XIP RAM that is permanently taken up by control code that cannot be unloaded, and consequently reduces manufacturing costs.

It is further known to those skilled in the art that this division of embedded software into two parts, which would normally have to be mounted by the operating system as two separate volumes or partitions, can result in much accidental complexity. This is true both for software developers (at all stages of the value chain from manufacturers to third parties) and also for the end users of this type of computing device. The complexity results from the fact that it is not going to be immediately apparent whether a particular software module or component is
a) part of the Core OS and is therefore immediately available; or
b) accessible via the section of the software left in NAND Flash, in which case it needs to be loaded into XIP RAM before it can be used.

However, those skilled in the art are aware that this accidental complexity can be obviated by providing a method of making both the software modules provided as part of the Core OS and the software modules remaining in NAND Flash appear as part of a single composite file system, with any loading of modules being handled transparently without any action needed on the part of the software developer or the user. A method of achieving this is described in GB2404748A “Computing Device And Method”.

While the division of embedded software into core and non-core categories as described above remains a valuable method, it may no longer reflect the complexity of the contents of the embedded software on many modern computing devices. These now have a wider range of potential divisions in both the code and, increasingly, in the data that goes into the ROM.

These divisions can be driven by market requirements, which may include, without being limited to:
the requirements of different geographical regions, such as the need for different languages;
the customisation requirements of the various resellers of electronic consumer devices (for example, branding and special features may be required for mobile phones by network operator and for set-top boxes by cable and satellite television providers);
divisions imposed by manufacturers, which serve to isolate blocks of functionality that can be developed, tested and integrated independently. This type of division is especially important for those manufacturers who provide different models in a range of computing devices, where some of the embedded software is common to all models in the range while other parts of the embedded software may be present only in some models but not in others of the range.

As an illustration, a typical division of the embedded software in a computing device might constitute four parts:
1) The core code and data which is common to all variants of that device.
2) The language and localisation code and data.
3) Further code and data customisations such as additional applications for certain geographical or other markets.
4) Reseller customisations, such as branding and bespoke applications.

It will be evident to those skilled in the art that still further subdivisions are possible: the above sub-division is merely exemplary.

An important consideration for manufacturers of devices that include embedded software is the time and expense required to build and test the separate parts separately and in combination. The set of commercially significant permutations for the four divisions outlined above can easily comprise 50 or more variations and it is impractical to manufacture each variant if it is necessary to rebuild and re-test the entire set each time any of the parts is changed.

Ideally, then, the separate divisions should be constituted as separate independent ROM images, where a ROM image may be defined as a file containing the binary data that will be programmed as embedded software into the computing device, and for which the contents of each one of these images can be independently tested and verified separately from the other ROM images. The images are then programmed into different areas, or partitions, in the memory of the computing device as separate embedded software sections, either at the same time or in a piecemeal fashion at different times.

Conveniently, these images may, in essence, be regarded as separately accessible ROMs, with the contents of all but the core OS image needing to be loaded into XIP memory before they can be executed, via logically separate Read-Only Filesystems (ROFS).

The term filesystem is used to refer specifically to the arrangement of directories and files within a ROM image together with the metadata used to describe this organisation. Typically, a filesystem is organised into a hierarchy, consisting of a tree of directories, and these directories can contain files and/or subdirectories.

The term directory refers to the method of grouping and organising files within a filesystem. It should be noted that a directory can contain zero or more files and can contain other directories. A directory within another directory is termed a subdirectory, and a directory containing such a subdirectory is called its parent. The topmost directory in the filesystem hierarchy is termed the root directory (frequently referred to as the root); all other files and directories exist below the root.

The term metadata refers to data held internally by the filesystem to manage the storage of files. Metadata contains important information about the files such as size, location, name and parent.

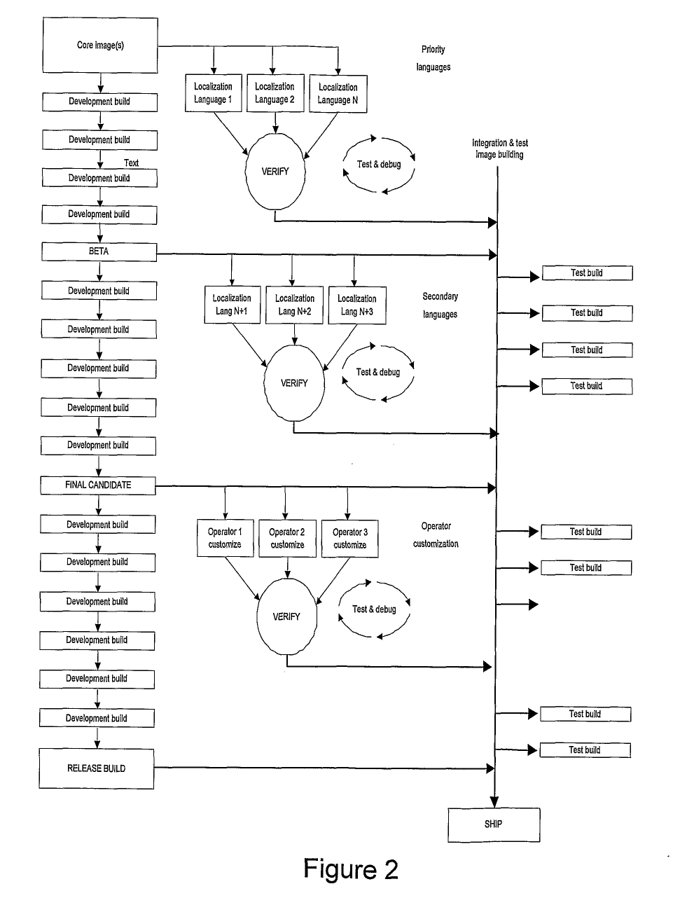

It should be noted that a filesystem stored in NAND Flash memory cannot be randomly accessed in the same way that a Core OS filesystem in RAM can be; it has to be read indirectly, via a media driver of some type. The concept, properties and construction of this type of ROFS is well known to those skilled in the art. FIG. 2 shows an example, where localisation (such as language) and customisation (such as mobile phone network or cable television provider requirements) are built and tested separately.

This technique of splitting the embedded software thus creates separate partitions for each of the ROM images, which collectively constitute the embedded software for the device. The individual files contained in these partitions must be presented to and made accessible to the operating system software controlling the device via some type of ROFS.

It is of course possible for the multiple separate ROM images to be presented to the device and its operating system software as a plurality of separate ROFS images. It is however far preferable for these ROM images to be presented as a single unified ROFS image. The advantages to the unified filesystem approach include:
1. Application writers do not need to consider which filesystem other files might appear on; they can assume that the entire ROM appears as a single filesystem.
2. Files can be moved around between ROM images during the manufacturing process without changing the view the operating system and applications see of the entire set of available files. Changing the location of a file does not break the embedded software in the device.
3. The number of ROM images can be changed without breaking either the operating system or the application software, as the different images are completely transparent.
4. A file in one ROM image can replace one in a subsequently added ROM image. This is useful for reseller customisation, as it allows the replacement of the manufacturer-supplied default implementation with a vendor-specific one.

There are methods of making one filesystem look as if it is a part of another filesystem. Amongst those well known to those skilled in the art is the SUBST command used by Microsoft operating systems, and the type of symbolic link used by Unix and Linux operating systems. However, these do not produce a truly unified file system, convey none of the advantages, and also have considerable size and speed overheads.

While GB2404748A referred to above does disclose a method by which a core OS image and a single ROFS can be presented to the operating system software as a single composite file system, it does this by layering such a file system above the duality of discrete directory lists; it assumes that a computing device possesses only a Core OS image and a single ROM image that need to be integrated in a single composite file system.

But, as we have described above, it is increasingly common for a modern computing device to have a plurality of ROM images in addition to its Core OS. Those skilled in the art would probably handle such a situation by adapting the system presented in GB2404748A to support multiple ROM images in a composite file system by layering a unified composite file system above a plurality rather than a simple duality of discrete directory lists.

However, such an approach turns out in practice to be less than satisfactory. It means that individual software modules have to be located by iterating through each of the separate directory lists in some pre-defined order. For example, to open a file the composite file system may first attempt to open it via its list of what is contained in the Core OS image, and if this fails, may then look through its list of the files in the separate ROM images sequentially, one after the other.

The more complex the construction of the embedded software, the more likely it is to introduce inefficiencies. No matter what the priority order of searching the Core OS and various ROFS images might be, it will always take longer to find files that reside in the lowest-priority image because they are found by sequentially searching the higher priority images in a serial fashion. And, in practice, the order of images is not random, but determined by the order in which file replacements are required to work in cases where a particular component is superseded by a customised version. This order will generally start with the most recently added ROM image and end with the core OS image. This is the case even when one would ideally want file lookups to be faster from the core OS image as it contains the most frequently used files. This can mean that relatively high priority files can be found residing in relatively low priority images; and vive versa.

The use of the known methods to solve this problem is surprisingly inefficient in terms of both time and also of power consumption, and inevitably slows the system down and wastes energy; this last issue is of particular concern for battery operated mobile devices such as mobile phones because these are expected to operate autonomously for relatively long periods of time from a relatively small internal battery power source. Hence, the existing technology is unable to deal efficiently with computing devices which contain embedded software built up from a plurality of discrete ROM images.

This invention seeks to provide a computing device in which the directory lists of the multiple ROM images are presented as a single merged directory hierarchy.

According to a first aspect of the present invention there is provided a computing device comprising a body of embedded software constructed from a plurality of images, wherein each image contains an independent filesystem containing a directory hierarchy and file list applicable to file data contents of that image, and wherein the computing device additionally contains a single directory hierarchy and file list applicable to the entire body of embedded software.

According to a second aspect of the present invention there is provided an operating system for controlling the operation of a computing device according to the first aspect.

Embodiments of the present invention will now be described, by way of further example only, with reference to the accompanying drawings, in which:—

FIG. 1 shows an architecture for a computing device having both XIP and non-XIP memory;

FIG. 2 shows a typical method for the construction of a ROFS image where localisation (such as language) and customisation (such as mobile phone network or cable television provider requirements) are built and tested separately;

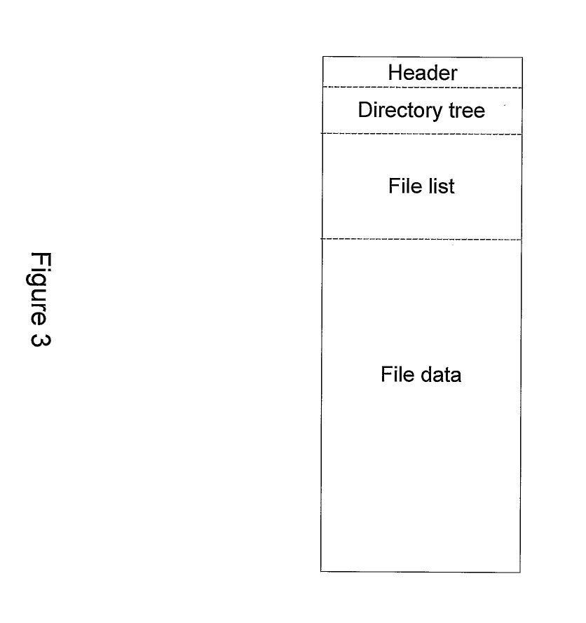

FIG. 3 shows schematically the layout of a ROM image according to the present invention;

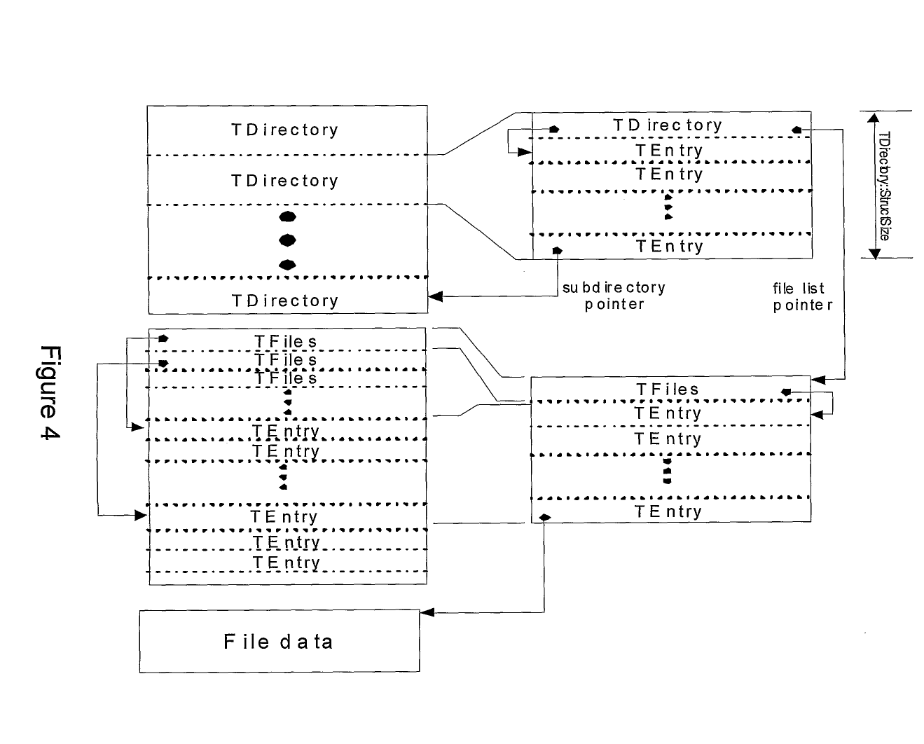

FIG. 4 shows an example of how data structures can be linked together to help form a complete filesystem in an operating system for a mobile telephone;

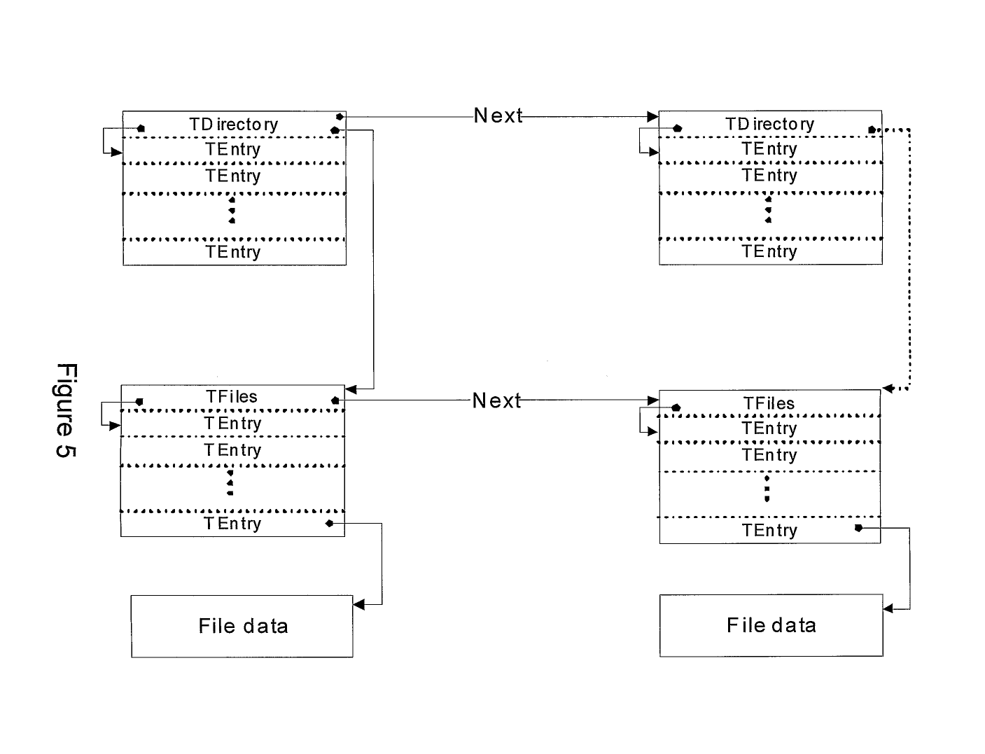

FIG. 5 shows how a directory appearing in two ROM images is merged together by linking the directory and file lists together in accordance with the present invention;

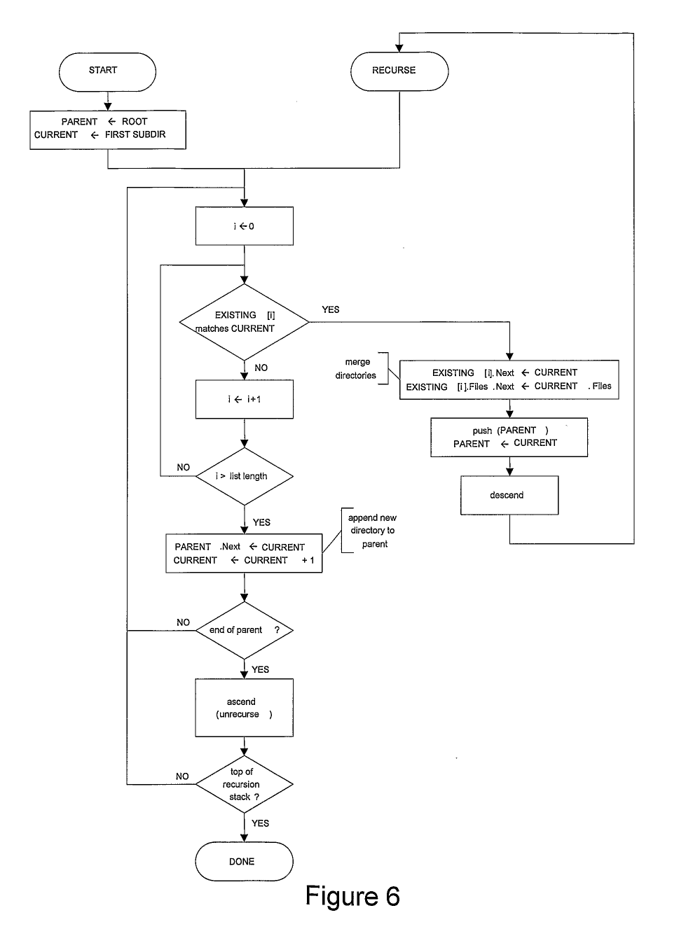

FIG. 6 shows in flowchart form a method for merging two filesystems; and

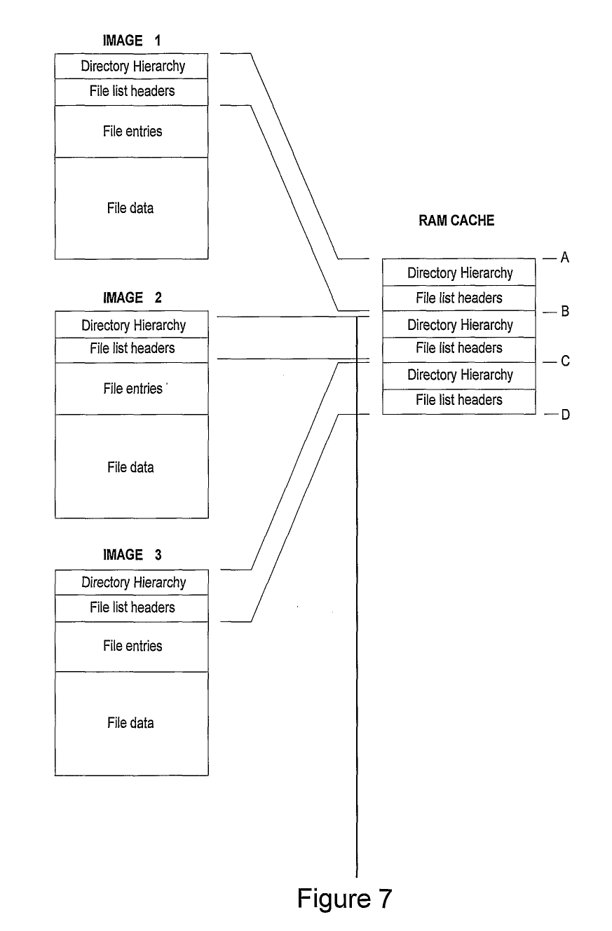

FIG. 7 shows schematically a method for determining which ROM image a file is located in when filesystems have been merged.

The present invention provides a filesystem layout that is optimised for use with non-XIP ROMs; and with an inbuilt ability to merge multiple ROM images into a single filesystem layout.

With the invention, a ROM image is split into three major parts:
1) The directory hierarchy
2) The lists of files within each directory
3) The contents of the files

There is also a header which contains pointers to each of these parts. This layout is shown in FIG. 3.

It is important that the metadata (directory hierarchy and file lists) is separated from the file data. This has two principal benefits:
Many types of storage medium are more efficient to access sequentially rather than random-access. Sequential access is either faster, or involves a lower CPU overhead, or both. It therefore follows that it is more efficient to perform directory searches when all the relevant metadata is collected in one place within the image instead of being scattered around the entire image.
It is easier to cache the directory and/or file lists into RAM for faster lookup when they exist as contiguous regions rather than scattered small fragments.

Caching is a well known technique for keeping data available in a temporary but quickly available memory store when it might otherwise need to be accessed repetitively from a slower storage medium. In the case of ROFS, which, as described above, have to be read via a media driver of some type, traversing the directory tree of the filesystem can be very inefficient when done directly from media as it can require many reads of small structures to reach the desired directory. For this reason, ROFS gain substantially in performance when their directory information is cached in RAM, either in full or in part.

It is also important that the directory hierarchy is separate from the lists of which files exist in each directory. Directories and subdirectories are listed in the directory tree section. The lists of files within each directory and subdirectory are listed separately within the file list section. This also has two benefits:
Separating the directory hierarchy information from the file lists speeds up searching for full specified file names. This is because the search for its parent directory only has to search through the list of directories, not through the entire list of files. Once the parent directory is found, the search then proceeds for the list of files within that directory. This is described in more detail below.
Because the directory hierarchy is generally fairly small compared to the file list, it is both practical and convenient to permanently cache the directory hierarchy in RAM, but load the larger file list in sections as required. It would be wasteful of RAM to try and cache the entire directory.

To see how searching works, consider a filesystem containing these files and directories (where angle brackets < > indicate a directory):

```
<data>
    icons.dat
    boot.ini
    <locale>
        language.dat
        timezone.dat
    <config>
        system.cfg
        network.cfg
```

To load the file \data\config\system.cfg the operating system must perform these steps:
1) Search the root directory for the subdirectory called “data”.
2) Search the <data> directory for the subdirectory called “config”
3) Search the <config> directory for the file called “system.cfg”

Obviously, time would be wasted if the search through <data> for <config> also has to consider the entries for the files “icons.dat” and “boot.ini”. As these are files, they clearly cannot match a search for a subdirectory. This overhead could be reduced by collecting all the subdirectory entries together and storing them at the start of each directory listing, followed by the file entries. However, such a solution is sub-optimal, as it means a file search would have to skip over all the subdirectory entries to reach the first file.

Therefore it is clearly a more efficient mechanism to store the hierarchy and file lists separately. The ability to conveniently cache the relatively small directory hierarchy information in RAM speeds up searches even further.

With the split hierarchy/file information, the above example directory would be laid out in the ROM image as follows:

```
DIRECTORY HIERARCHY
<data>
    <locale>
    <config>
FILE LIST
From data ->
    icons.dat
    boot.ini
From locale ->
    language.dat
    timezone.dat
From config ->
    system.cfg
    network.cfg
```

It can be seen that the directory hierarchy section is compact, and contains only the information needed to search for the parent directory of the file. Once the parent directory has been located the file list for that directory can then be searched for the required file.

In the context of the present invention, the term merging refers to the method of taking the directory hierarchy and file lists of multiple ROM images, and proceeding to construct a single directory hierarchy and file list that applies across all the ROM images. In this embodiment of the invention, this is done by creating metadata in a form that can be combined for directories that are identical in the filesystems of different ROM images.

The following cases exist when merging multiple filesystems:
1) A filesystem defines a directory that appears in one or more other filesystems
   Each filesystem's entries for this directory must be merged together and the file lists for this directory are also merged
2) A filesystem defines a directory that does not appear in any other filesystems
However, at some point there must be a common parent directory that exists in one or more filesystems; this could be the root directory. That parent directory then is identical to case (1).

As all files exist within a directory, and all directories must have a parent directory (which could be the root) the merging essentially is the process of merging directories that are common to one or more filesystems.

Each directory entry contains a link pointer allowing it to link to another directory entry. By doing this a single large directory can be created as a linked-list of smaller parts. So, if multiple ROM images all contain a directory <foo> the single composite directory <foo> is created by joining the separate <foo> entries together into a linked-list.

The same is done with the list of files for each directory. Each directory's file list contains a link pointer allowing it to form a linked-list with other file lists for the same directory.

This can be shown by the following example, which shows two simple filesystems to be merged:

| FILESYSTEM A | FILESYSTEM B |
|---|---|
| <data> | <data> |
| <network> | <locale> |
| hosts.cfg | language.dat |
| config.cfg | |
| tcpip.cfg | |

Filesystem A has a <data> hierarchy list which has only one entry, that for the <network> subdirectory and it doesn't have any files so there isn't a file list. Similarly Filesystem B has a <data> hierarchy entry which contains only the subdirectory entry <locale> and no file list.

The only common point between the two filesystems is the parent directory <data>, so it is this directory which will be merged. The <data> entry from Filesystem A will be linked to the <data> entry in Filesystem B. Since there aren't any files in the <data> directory, there aren't any file lists to be linked together. This will produce a linked-list for the hierarchy of data containing the subdirectories <network> (from Filesystem A's hierarchy entry for <data>) and <locale> (from Filesystem B's hierarchy entry for <data>)

```
<data>
    <network>
        hosts.cfg
        config.cfg
        tcpip.cfg
    <locale>
        language.dat
```

If the filesystems also contain some files within a shared directory these are merged. This process can be seen from the following example.

| FILESYSTEM A | FILESYSTEM B |
|---|---|
| <data> | <data> |
| <network> | <network> |
| hosts.cfg | bluetooth.dat |
| config.cfg | |
| tcpip.cfg | |

Now it is the <network> directory that is common between the two filesystems. In this case the <network> hierarchy entries are not merged, but the file list from Filesystem B is linked to the end of the file list from Filesystem A. This gives the intended merged filesystem:

```
<data>
    <network>
        hosts.cfg
        config.cfg
        tcpip.cfg
        bluetooth.dat
```

Combining these two cases allows merging of a case where there are both subdirectories and files within a common parent directory, as shown below.

| FILESYSTEM A | FILESYSTEM B |
|---|---|
| <data> | <data> |
| <network> | <network> |
| hosts.cfg | bluetooth.dat |
| config.cfg | <resource> |
| tcpip.cfg | icons.dat |
| <locale> | |
| language.dat | |

The merging of the <network> directory is achieved by linking the file list for this directory from Filesystem A to the file list for this directory in Filesystem B, as described in the previous example. The merging of the <resource> subdirectory from Filesystem B into the <data> parent directory is done by linking the <data> directory entry from Filesystem A to the <data> directory entry from Filesystem B. This creates two entries for the <network> subdirectory so the one from Filesystem B is disabled using the delete flag described below.

In this case it is also possible to leave both <network> entries and not join the file lists. This reduces the amount of CPU effort required to perform the merge but means that the when looking up a file, the filesystem has to search through all entries of the parent directory for multiple instances of a matching subdirectory name, and then search the file lists of each of those. The reduced effort in merging is offset by an increased effort in searching for files.

If two or more filesystems define the same file then only one can appear in the merged filesystem. A precedence order is used to determine which file is taken for the merged filesystem.

The precedence order can be defined in various ways, including:
1) Defining a precedence order of ROM images, e.g. files in image A can replace files in image B, and files in A or B can replace files in C
2) Defining a precedence for individual files. In this case the file entries contain a precedence number and the file with the higher precedence number will be taken.

If the file list entries were just linked together there would be multiple entries for the files. To avoid having to rebuild the file list, each file list entry contains a “delete flag”. This delete flag is set for each replaced instance of the file; only the file with the highest precedence will not have the delete flag set. Entries with the delete flag set will be ignored in file searches and listings of filesystem content. The entry is effectively deleted without actually having to rebuild the file list to remove it.

Another advantage is that the delete flag can be revoked and the original file can then reappear—this is useful if ROM images can be reprogrammed individually and the filesystem merging is being performed in-ROM: this is described in more detail below. If filesystem A replaces the file language.dat in filesystem B, the delete flag will be set on the file entry in filesystem B. If filesystem A is reprogrammed and now does not contain the language.dat file, the delete flag in filesystem B is cleared so that the language.dat file from filesystem B reappears.

Instead of replacing files, a ROM image may want to just delete a file that exists in another filesystem. This is done by creating a file list entry that already has the delete flag set. If this entry has higher precedence than entries in other ROM images then all others will also be marked deleted. The result is that there are no visible entries for that file.

Sometimes it might be necessary to ensure that a file cannot be deleted. For example preventing a virus scanner or encryption library from being replaced. File entries can also have a “never delete” flag, if this is set any duplicate entries that would normally replace this entry are instead set to deleted and this entry remains.

An entire directory from one filesystem can be replaced by one in another filesystem. The method for this is similar to that with files. Each directory hierarchy entry has a “delete flag” so that it can be effectively deleted. Behaviour of the delete flag is as described above for files.

However, normal behaviour is to merge the content of duplicate directories. To change this behaviour each directory has a “replace” flag. If this flag is set, it will be treated as replacing duplicate directory entries of lower precedence instead of being merged with them.

Directories also have a “never delete” flag just like files so that a directory cannot be replaced by one from another ROM image.

FIG. 4 shows an example of how data structures might link together to help form a complete filesystem in Symbian OS, the advanced operating system for mobile telephones from Symbian Ltd. This example is provided for illustrative purposes only, and is not intended to limit the invention in any way. Those skilled in the art will be aware that the different structures and techniques may be needed for different operating systems. Those skilled in the art of programming for Symbian OS will also be aware that TDirectory and TEntry are Symbian OS standard names for directory objects and directory entry objects respectively; more details on these objects are given below.

### General Entry

An entry contains the name and attributes for a file or subdirectory, and internal metadata. Attributes are characteristics of files or directories, such as size, write-protection, hidden. The entry consists of a fixed-size structure followed by a variable-size name string.

struct TEntry

| { | | |
|---|---|---|
| int | StructSize; | // total size of TEntry plus length of Name |
| int | Att; | // attributes |
| int | DataSize; | // size of file data or subdirectory block |
| int | DataOffset; | // offset to file data or subdirectory block |
| int | Flags; // filesystem flags | |
| int | NameLength; | // length of Name array |
| char | Name[1]; | // variable-length name string |
| }; | | |

Because the name is variable length the first member of the entry is a total size from the start of the entry to the end of the name string.

The Flags section contains internal filesystem flags as follows:
Deleted—this entry has been deleted during merging
Never delete—this entry must never be deleted
Replace—for a directory indicates that this entry should replace duplicates instead of being merged with duplicates

This entry can be used for either a file or for a subdirectory. When used for a file, the DataSize is the total number of bytes in the file data and the DataOffset is the offset of the start of the file data within the file data area shown in FIG. 3.

When used for a subdirectory the DataOffset points to the start of the directory list (TDirectory) for the subdirectory. DataSize is not used.

Further operating-system information can be added to this structure, such as timestamp, access permissions, etc.

### Directory List

The directory list exists within the hierarchy section of the ROM image shown in FIG. 3, and lists all the subdirectories plus a pointer to the file list. It is constructed as a header followed by a number of general entries for each subdirectory

| | |
|---|---|
| struct TDirectory | |
| { | |
| int FirstTentryOffset; | // offset to first TEntry |
| int FileListOffset; | // offset to associated file list |
| TDirectory* Next; | // linked-list pointer |
| }; | |

FirstTentryOffset points to the list of TEntry structures for all the subdirectories within this directory. This is zero if the directory doesn't contain any subdirectories.

FileListOffset points to the file list (TFiles) for the files within this directory. This is zero if the directory doesn't contain any files.

Next is a pointer used to create a linked-list when merging directories. If the same directory exists in another filesystem, the Next pointer will link the two subdirectory lists together. If the file lists are also merged only the FileListOffset of the first TDirectory is significant. If the file lists are not merged then each TDirectory points to a group of files within the merged directory.

### Directory Hierarchy

The directory hierarchy is the section of the ROM image containing the overall metadata describing the layout of directories and subdirectories but not containing the file list. It is a flat list of TDirectory entries and their associated TEntry lists for subdirectories. The hierarchy is created by links from TEntry objects to TDirectory lists.

### File List

A file list is formed in a similar way to a directory list, with a header structure and a list of TEntry objects

| struct TFiles | |
|---|---|
| { | |
| int FirstTentryOffset; | // offset to first TEntry |
| int EntryListLength; // total length in bytes of TEntry list | |
| TFiles* Next; | // linked-list pointer |
| }; | |

FirstTentryOffset points to the first TEntry in the list of files. There is a TEntry for every file.

EntryListLength is the total length in bytes of the list of TEntry objects pointed to by FirstTentryOffset.

The TFiles headers are grouped together separately from their TEntry lists so that they can be cached into RAM and the linked-lists created in RAM while the (much larger) TEntry lists can be loaded on demand.

Next is a pointer used to create a linked-list when merging directories. If the same directory exists in another filesystem, the Next pointer will link the two file lists together.

### File Data Area

The file data area just contains the binary data for the contents of all files in the ROM image. There isn't any metadata in this area because this is all held in the TEntry objects within the file list area.

### Header

The header contains as a minimum offsets to each of the areas within the ROM image.

```
struct THeader
    {
    int  DirectoryHierarchyOffset;// offset to root TDirectory
    int  DirectoryHierarchySize; // total size of directory hierarchy
    area
    int  FileListOffset;  // offset to file list header area
    int  FileListSize; // total size of file list headers
    int  FileEntriesOffset;// offset to file list entry area
    int  FileEntriesSize;  // total size of file list entries
    int  FileDataOffset;  // offset to start of file data area
    int  FileDataSixe;// total size of file data area
    };
```

Other operating-system specific data can be added to this header, such as version number, timestamp, etc.

FIG. 5 shows how a directory appearing in two ROM images is merged together by linking the directory and file lists together.

The process of merging can be done at any or all of three different stages:
build-time
in-flash
runtime.

### Build-Time Merge

The ROM images are run through a build step which merges the filesystems together before the images are programmed into ROM. The linked-list pointers are written into the images.

### In-Flash Merge

The ROM images are merged together after they have been programmed into a writable ROM (such as Flash memory). The linked-list pointers are written into the images in ROM.

### Runtime Merge

The runtime merge happens at runtime each time the device is booted. The directory hierarchy and file list headers (TFiles) for all ROM images are loaded into RAM and then they are compared and merged.

FIG. 6 shows a flowchart for merging two filesystems. This is a simple recursive directory walk, comparing the new filesystem (CURRENT) with the existing filesystem (EXISTING) that it is to be merged into. There are two cases, either the new filesytem contains a directory which is not in the existing filesystem and is appended to the common parent directory. Or, the filesystem contains a duplicate directory which must be merged with the existing directory.

### Finding the ROM Image

When the filesystems have been merged there is one list for all subdirectories and files, but information needs to be preserved about which ROM image a file is located in. This can be done simply by comparing the location of the TFiles header against its location in the cache. The directory hierarchy from each filesystem will have been loaded into RAM as a block, so by comparing the addresses of each of these blocks the ROM image, containing the file can be found.

An example is shown in FIG. 7. in this example, the header data for ROM image 1 is copied into the RAM cache between addresses A and B. Likewise the header data for ROM image 2 is copied between addresses B and C, and that for ROM image 3 between addresses C and D.

So, for example, if while traversing a merged list of files the matching TEntry is found in a list with a header between addresses B and C in the cache, then the file data is in ROM image 2.

The following use cases illustrate some of the benefits of this invention:
a) More files are added to a directory. The linked-list pointer of the first set of files is changed from NULL to point to the list of added files.
b) More subdirectories are added to a parent directory. As with (a) the linked-list pointer of the existing subdirectory list is pointed to the list of additional subdirectories.
c) Files or directories from an existing list are hidden. The deleted flag is set on all those entries in the existing list
d) Hidden files or directories from an existing file list are “unhidden”. The deleted flag is cleared on all those files in the existing list
e) A file or directory entry is replaced by one in another image. The original entry is set to deleted.

Although the present invention has been described with reference to specific embodiments it is to be understood that modifications can be effected whilst remaining within the scope of the appended claims.

1. A computing device comprising:
a body of embedded software constructed from a plurality of images, wherein each image contains an independent filesystem containing a directory hierarchy and file list applicable to file data contents of image; and
a single directory hierarchy and file list applicable to the entire body of the embedded software.

2. A computing device according to claim 1 wherein the single directory hierarchy and file list applicable to the body of the embedded software is constructed before the images are embedded in the computing device and is embedded in persistent memory storage with the images.

3. A computing device according to claim 1 wherein the single directory hierarchy and file list applicable to the body of the embedded software is constructed after the images are embedded in the computing device and is then written to persistent memory storage.

4. A computing device according to claim 1 wherein the single directory hierarchy and the file list applicable to the entire body of embedded software is constructed when the computing device is powered-up and is written to non-persistent memory storage.

5. A computing device according to claim 1, wherein the said directory hierarchies and file list applicable to file data contents are arranged to be separated from the file data contents.

6. A computing device according to claim 1, wherein, for each directory, the directory hierarchies are separate from the file list applicable to file data contents.

7. A computing device according to claim 1, wherein the single directory hierarchy and the file list applicable to the entire body of embedded software is constructed by merging entries in directories that are common to two or more of the plurality of images into a single directory.

8. A computing device according to claim 7 wherein two or more images define same file, and wherein a precedence order is used to determine which file is accessible via the single directory hierarchy and the file list.

9. A computing device according to claim 8, wherein the plurality of images making up the embedded software has a precedence order and the precedence order used to determine which file is accessible via the single directory hierarchy and the file list is based on the precedence order for the plurality of images making up the embedded software.

10. A computing device according to claim 8 wherein the precedence order is embedded as metadata in an appropriate entry in the file lists.

11. A computing device according to claim 1 wherein an entry in the file list includes a flag, the flag is set to indicate that the entry is to be ignored for listing and searching purposes, or reset to indicate that the entry is not to be ignored.

12. A computing device according to claim 1, wherein an entry in the file list or the directory hierarchy includes a flag the flag set to indicate that the entry is not to be ignored, and wherein any other entries duplicating entry are to be ignored.

13. A computing device according to claim 1 further comprising a memory configured to cache the single directory hierarchy.

14. A computer program product comprising an operating system for controlling the operation of a computing device the operating system comprising:
a body of embedded software constructed from a plurality of images, wherein each image contains an independent filesystem containing a directory hierarchy and a file list applicable to file data contents of the image; and
a single directory hierarchy and a file list applicable to the entire body of the embedded software.

15. A method of operating a computing device comprising:
providing a body of embedded software constructed from a plurality of images, in which each image contains an independent filesystem containing a directory hierarchy and a file list applicable to the contents of the image; and
configuring the computing device to contain a single directory hierarchy and file list applicable to the entire body of the embedded software.

16. A method of operating a computing device according to claim 15, wherein the single directory the hierarchy and file list applicable to the entire body of the embedded software is constructed before the images are embedded in the computing device and is embedded in a persistent memory storage along with them.

17. A method according to claim 15, wherein the single directory hierarchy and the file list applicable to the entire body of the embedded software is constructed after the images are embedded in the computing device and is then written to a persistent memory storage.

18. A method according to claim 15, wherein the single directory hierarchy and the file list applicable to the entire body of the embedded software is constructed when the computing device is powered-up and is written to a non-persistent memory storage.

19. A method according to claim 15, wherein the directory hierarchies and the file list applicable to file data contents are separated from the file data contents.

20. A method according to claim 15, wherein the single directory hierarchy and file list applicable to the entire body of embedded software is constructed by merging entries in directories that are common to two or more of the plurality of images into a single directory.
